(19) United States
(12) Patent Application Publication
(10) Pub. No.: US 2025/0381790 A1
(43) Pub. Date: Dec. 18, 2025

(54) PRINTING APPARATUS

(71) Applicant: Toshiba Tec Kabushiki Kaisha, Tokyo (JP)

(72) Inventor: Masakazu KATO, Numazu Shizuoka (JP)

(21) Appl. No.: 19/050,342

(22) Filed: Feb. 11, 2025

(30) Foreign Application Priority Data
Jun. 14, 2024 (JP) 2024-096907

(51) Int. Cl. B41J 29/393; B41J 2/325; B41J 3/407; B41J 33/00; B41J 33/16

(52) U.S. Cl. CPC B41J 29/393; B41J 2/325; B41J 3/4075; B41J 33/003; B41J 33/16; B41J 2029/3937

(57) ABSTRACT

In accordance with an embodiment, a printing apparatus includes a shaft and an antenna. The shaft is arranged to be inserted into a tubular material including a wireless tag and rotatably supports the tubular material. The antenna performs data communication with the wireless tag. The antenna has an antenna element group and the antenna element group is arranged to cover an area in a circumferential direction of the shaft.

### CROSS-REFERENCE TO RELATED APPLICATION

This application is based upon and claims the benefit of priority from the prior Japanese Patent Application No. 2024-96907, filed on Jun. 14, 2024, the entire contents of which are incorporated herein by reference.

### FIELD

An embodiment described here generally relates to the printing apparatus.

### BACKGROUND

Thermal printers such as label printers perform printing by conveying an ink ribbon over a print sheet and transferring ink in the ink ribbon to the print sheet through a thermal head. The thermal printer may perform printing control settings such as speed depending on the type of ink ribbon used. Some conventional thermal printers perform printing control settings on the basis of data scanned from a wireless tag installed in a ribbon roll wound with an ink ribbon.

However, it is sometimes difficult for a reader/writer installed in a thermal printer to scan data from a wireless tag installed in a ribbon roll depending on a positional relationship between the wireless tag and its antenna. It is thus desirable for a printing apparatus such as a thermal printer to perform data scanning that can reliably scan data of a wireless tag installed in a ribbon roll.

### BRIEF DESCRIPTION OF THE DRAWINGS

FIG. 1 is a schematic view showing a label printer according to an embodiment.

FIG. 2 is a partially enlarged perspective view showing main parts of a feed shaft of the label printer shown in FIG. 1.

FIG. 3 is an exploded perspective view of the feed shaft in FIG. 2.

FIG. 4 is a perspective view showing a paper tube of the ribbon roll mounted on the feed shaft in FIG. 2.

FIG. 5 is a block diagram showing an exemplary control system of the label printer shown in FIG. 1.

FIG. 6 is a diagram showing exemplary results of success or failure of data scanning for each angle of an IC tag, which is performed by a conventional antenna.

FIG. 7 is a schematic view showing a state in which the angle of the IC tag relative to the conventional antenna is 0 degrees.

FIG. 8 is a schematic view showing a state in which the angle of the IC tag relative to the conventional antenna is 90 degrees.

FIG. 9 is a view showing an exemplary antenna.

FIG. 10 is a diagram showing exemplary results of success or failure of data scanning for each angle of the IC tag, which is performed by the antenna mounted on a fixation shaft in FIG. 9.

FIG. 11 is a schematic view showing a state in which the angle of the IC tag relative to the antenna in FIG. 9 is 0 degrees.

FIG. 12 is a schematic view showing a state in which the angle of the IC tag relative to the antenna in FIG. 9 is 90 degrees.

FIG. 13 is a view showing a modified example of the antenna in FIG. 9.

FIG. 14 is a view showing a modified example of the antenna in FIG. 9.

### DETAILED DESCRIPTION

In accordance with one embodiment, a printing apparatus includes a shaft and an antenna. The shaft is arranged to be inserted into a tubular material including a wireless tag. The shaft rotatably supports the inserted tubular material. The antenna has an antenna element group including a plurality of antenna elements and performs data communication with the wireless tag. The antenna element group is arranged to cover an area in a circumferential direction of the shaft.

Hereinafter, an embodiment will be described with reference to the drawings. It should be noted that in the figures used for the following description, the scale of each part may be changed as appropriate. Moreover, in order to make the descriptions easier to understand, the configurations may be simplified or omitted in the figures. Moreover, the same reference signs will denote the same or similar parts in the figures.

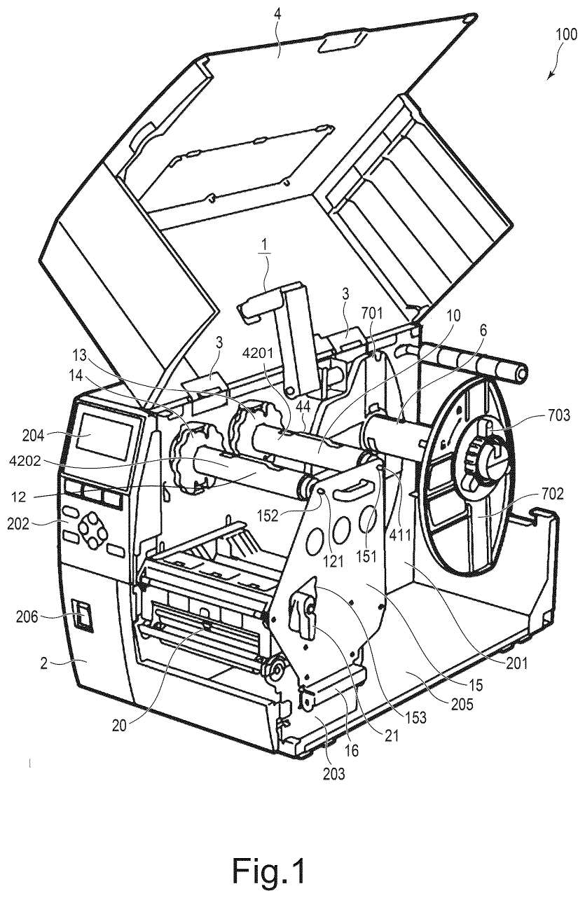

Hereinafter, a label printer 100 according to the embodiment will be described with reference to FIGS. 1 to 5. The label printer 100 is an example of a printing apparatus described in the scope of claims of this application.

FIG. 1 is a schematic view showing the label printer 100 according to the embodiment. As shown in FIG. 1, the label printer 100 includes a casing 2 and a cover 4. The cover 4 is rotatably connected to the casing 2 via two hinges 3. The cover 4 is rotatable between an open position shown in FIG. 1 to open the interior of the casing 2 and a close position to cover the interior of the casing 2. A damper 1 to make the opening and closing movement of the cover 4 smoother is provided between the cover 4 and the casing 2. When the cover 4 is closed, the label printer 100 has an outer shape like a substantially rectangular block.

An operation device 202, a display device 204, and a power switch 206 are provided in a front surface of the casing 2. The operation device 202 inputs information about label paper, the number of prints, and the like. The display device 204 displays operation information, an operation menu, and the like.

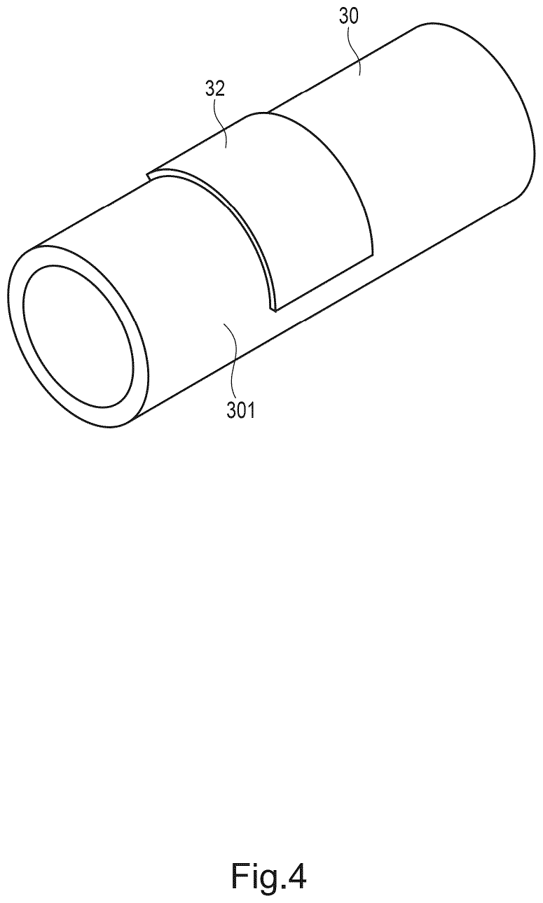

The label printer 100 includes a supply shaft 6 to mount a label paper roll, a feed shaft 10 to removably mount a ribbon roll obtained by winding the ink ribbon before use around a paper tube 30 (FIG. 4), a take-up shaft 12 to removably mount a ribbon roll to take up the ink ribbon after use, and a printing device 20. The printing device 20 is an example of a printing part.

The label paper roll is a roll of long, strip-shaped label paper. The label paper is a long backing sheet with a plurality of labels arranged and attached on a surface thereof. Each label has an adhesive layer on a surface closer to the backing sheet. The label is detachable from the backing sheet. The label is attachable to another object after the label is pealed off from the backing sheet. The label paper roll is the label paper wound around a core material so that the surface of the backing sheet on which the labels are attached is oriented inwards. The label paper is an example of the print sheet. The print sheet is not limited to the label paper. The print sheet may be, for example, strip-shaped thermal paper. The label paper roll is an example of a medium roll. The core material of the label paper roll is an example of a tubular material.

The ribbon roll is a long ink ribbon wound in a roll form. The ink ribbon retains ink to be transferred to the label paper by heat. The ribbon roll before use is the ink ribbon wound around the paper tube 30 before the ink is transferred, and decreases in diameter along with the use. The ribbon roll after use is the ink ribbon taken up after the ink is transferred, and gradually increases in diameter. That is, the ribbon roll after use is the ink ribbon pulled out from the ribbon roll before use, which is taken up on the downstream side of the printing device 20. The ribbon roll before use is an example of the medium roll. The paper tube 30 is an example of the tubular material.

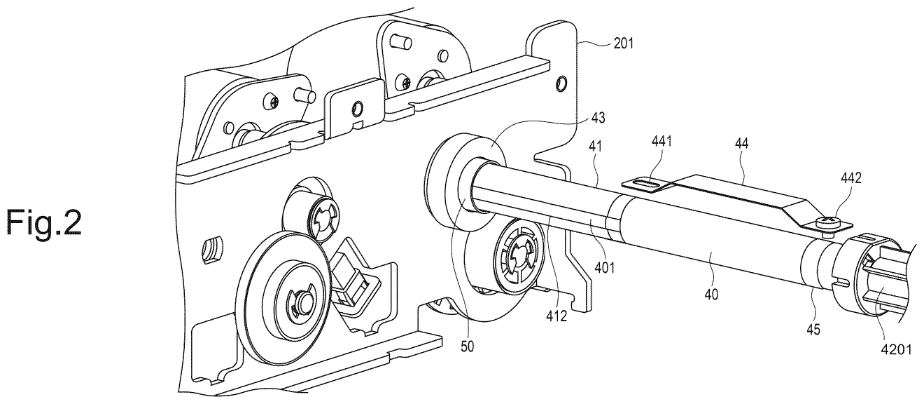

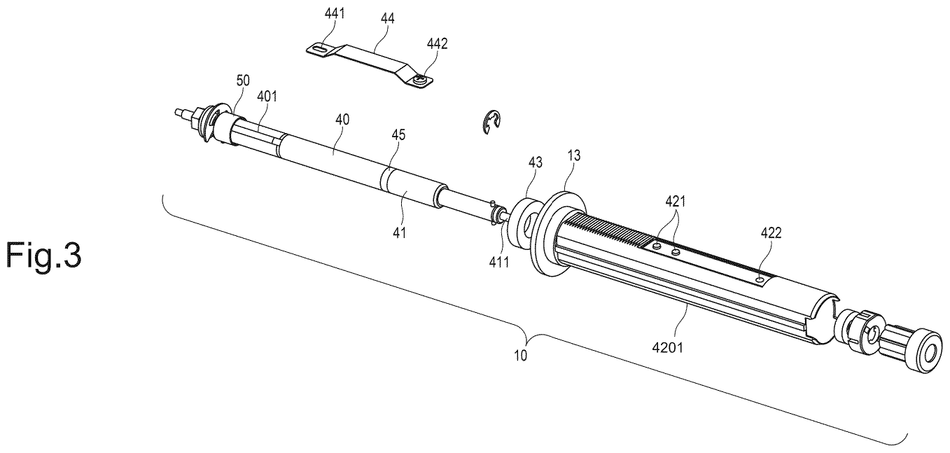

A side wall 201 of the casing 2 fixes one ends of the supply shaft 6, the feed shaft 10, and the take-up shaft 12. That is, the side wall 201 retains the three shafts 6, 10, and 12 in a cantilevered position. The take-up shaft 12 has substantially the same structure as the feed shaft 10 except for a characteristic in that an antenna 40 (FIGS. 2 and 3) to be described later is not provided. Therefore, a detailed description of the take-up shaft 12 will be omitted hereinafter.

The supply shaft 6 has two hold plates 701 and 702 near both ends in a longitudinal direction. The two hold plates 701 and 702 respectively come into contact with both end surfaces of the label paper roll in an axial direction. The hold plate 701 on the back side is movable along the longitudinal direction of the supply shaft 6. The hold plate 701 on the back side is closer to the side wall 201. The hold plate 701 determines an axial position where the label paper roll is mounted so that an axial center of the label paper roll is aligned with the center of the label printer 100. The hold plate 702 on the front side is fixed to the supply shaft 6 through a fastener 703. The hold plate 702 on the front side is mounted near an end portion of the supply shaft 6 on a side further from the side wall 201 of the casing 2.

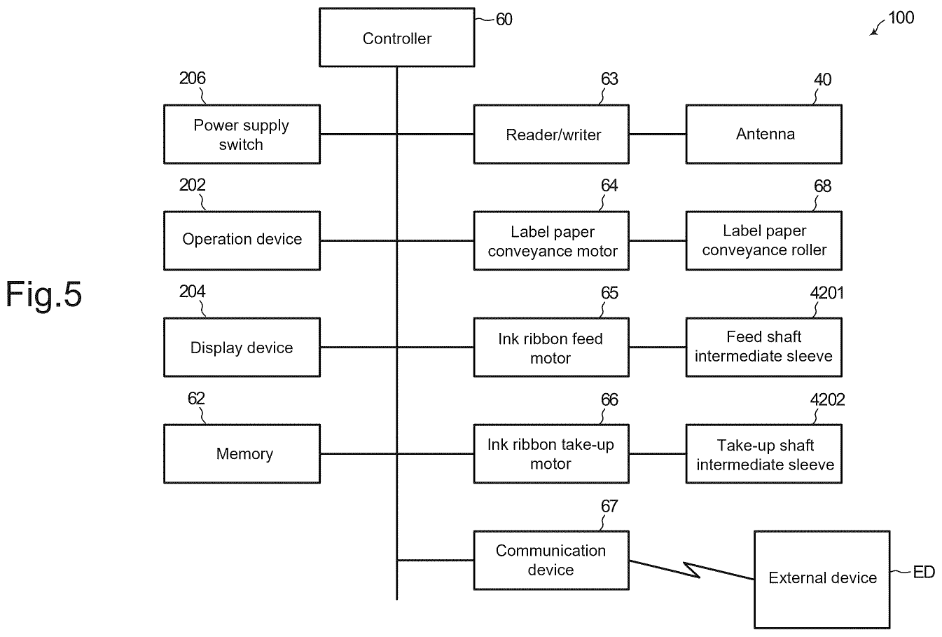

For mounting the label paper roll on the supply shaft 6, the label paper roll is mounted on the supply shaft 6 after the hold plate 702 on the front side is removed from the supply shaft 6. Then, the hold plate 702 on the front side is mounted on a front end portion of the supply shaft 6. The label paper of the label paper roll is pulled out from the label paper roll by a label paper conveyance roller 68 (FIG. 5), passes through the printing device 20, and exits the label printer 100.

The feed shaft 10 and the take-up shaft 12 of the ribbon roll respectively include stopper plates 13 and 14 near the side wall 201 of the casing 2. The stopper plates 13 and 14 are movable along the longitudinal directions of the shafts 10 and 12, respectively. The axial center of the ribbon roll is aligned with the center of the label printer 100 by bringing an axial end of the ribbon roll before use, which is mounted on the feed shaft 10, into contact with the stopper plate 13. The axial center of the ribbon roll is aligned with the center of the label printer 100 by bringing the axial end of the ribbon roll after use, which is mounted on the take-up shaft 12, into contact with the stopper plate 14.

A ribbon shaft fixing plate 15 is provided at a position where it faces front end portions of the feed shaft 10 and the take-up shaft 12, which are further from the side wall 201. The ribbon shaft fixing plate 15 is rotatably connected to a supporting plate 203 standing upward from a bottom wall 205 of the casing 2 via a hinge 16. The ribbon shaft fixing plate 15 has a receiving hole 151 and a receiving hole 152. The receiving hole 151 receives a tip end 411 (hereinafter, simply referred to as a tip end 411 of the feed shaft 10 in some cases) of a fixed shaft 41 of the feed shaft 10, which will be described later. The receiving hole 152 receives a tip end 121 of the take-up shaft 12. The ribbon shaft fixing plate 15 includes an insertion hole 153 to insert a head lever 21 of the printing device 20.

For mounting the ribbon roll on the feed shaft 10, the ribbon shaft fixing plate 15 is opened to a position (not shown), and the ribbon roll is mounted on the feed shaft 10. Then, the ribbon shaft fixing plate 15 is rotated to the position (see the figure), the tip end 411 of the feed shaft 10 is inserted into the receiving hole 151, and the tip end 121 of the take-up shaft 12 is inserted into the receiving hole 152. In this state, the ribbon shaft fixing plate 15 fixes the tip end 411 of the feed shaft 10 and the tip end 121 of the take-up shaft 12.

The ink ribbon pulled out from the ribbon roll mounted on the feed shaft 10 passes through the printing device 20 and is taken up by the take-up shaft 12. The printing device 20 conveys the ink ribbon over the label paper, and causes the ink ribbon to pass through the printing device 20 at the same speed as the label paper.

The printing device 20 includes a thermal head arranged on a side of the ink ribbon that is opposite to the label paper. The printing device 20 includes a platen roller at a position where it faces the thermal head with the ink ribbon and the label paper are located therebetween. The printing device 20 pushes the ink ribbon against the label paper through the thermal head to thermally transfer the ink in the ink ribbon to the label paper. The printing device 20 prints two-dimensional barcodes or the like on the labels of the label paper.

FIG. 2 is a partially enlarged perspective view showing main parts of the feed shaft 10 of the label printer 100. Moreover, FIG. 3 is an exploded perspective view of the feed shaft 10. As shown in FIGS. 2 and 3, the feed shaft 10 includes the fixed shaft 41 fixed to the side wall 201 of the casing 2 in a cantilevered position, an intermediate sleeve 4201 disposed on the same axis as the fixed shaft 41 outside the fixed shaft 41, and a bearing 43 disposed on the same axis as the fixed shaft 41 outside the fixed shaft 41. The fixed shaft 41 is an example of a shaft described in the scope of claims of this application. The intermediate sleeve 4201 is an example of a sleeve.

The fixed shaft 41 is, for example, a solid metal shaft and is fixed to the side wall 201 of the casing 2 with a bolt in a cantilevered position. The tip end 411 of the fixed shaft 41 protrudes from a front end portion of the intermediate sleeve 4201.

The intermediate sleeve 4201 has a substantially cylindrical shape. The intermediate sleeve 4201 has the bearing 43 inside it near an end portion closer to the side wall 201. The bearing 43 is fitted and fixed to the end portion of the intermediate sleeve 4201. The bearing 43 has a cylindrical shape and can be made of resin or metal. An inner diameter of the intermediate sleeve 4201 is substantially the same as an outer diameter of the bearing 43.

The intermediate sleeve 4201 is rotatable relative to the fixed shaft 41 through the bearing 43. The intermediate sleeve 4201 has the above-mentioned stopper plate 13 outside it near the end portion closer to the side wall 201. The stopper plate 13 is movable in a longitudinal direction of the intermediate sleeve 4201 and can be fixed at a desired position in the longitudinal direction.

Two bosses 421 and a screw hole 422 are provided in an outer circumferential surface of the intermediate sleeve 4201. The two bosses 421 are for positioning a leaf spring 44. The screw hole 422 is for fastening the leaf spring 44 to the outer circumferential surface of the intermediate sleeve 4201. The leaf spring 44 has a slit 441 to insert the bosses 421 at one end closer to the side wall 201 and has the screw hole 422 to allow a screw 442 to pass therethrough at the other end. The leaf spring 44 is fixed to the outer circumferential surface of the intermediate sleeve 4201 by inserting the bosses 421 of the intermediate sleeve 4201 into the slit 441 and engaging the screw 442 with the screw hole 422.

The leaf spring 44 is made of metal. The leaf spring 44 presses the inner surface of the paper tube 30 against its outside and fixes the paper tube 30 to the intermediate sleeve 4201 in a state in which the paper tube 30 of the ribbon roll is mounted outside the intermediate sleeve 4201. The leaf spring 44 projects from the outer circumferential surface of the intermediate sleeve 4201 to the extent that the intermediate sleeve 4201 can be inserted into the paper tube 30.

The sheet-shaped antenna 40 is provided in an outer circumferential surface of the fixed shaft 41. A wire 401 is provided in the outer circumferential surface of the fixed shaft 41. The wire 401 is electrically connected to the antenna 40 and extends in a longitudinal direction of the fixed shaft 41. The antenna 40 and the wire 401 are, for example, a continuous metal foil and may be a metal foil patterned on a surface of a flexible substrate. For example, the pattern of the antenna 40 has a loop antenna shape to form a magnetic field.

A magnetic sheet 45 is provided between the outer circumferential surface of the fixed shaft 41 and the antenna 40. The magnetic sheet 45 is provided so that the magnetic field formed by the antenna 40 generates eddy currents in the metal fixed shaft 41, and so that the magnetic field formed by the antenna 40 is not canceled out. Therefore, the magnetic sheet 45 has a size larger than the antenna 40 so that the magnetic sheet 45 exists between the antenna 40 and the fixed shaft 41.

The antenna 40 is spaced apart from the outer circumferential surface of the fixed shaft 41 by the thickness of the magnetic sheet 45, so an end portion of the wire 401, which is closer to the antenna 40, is slightly inclined toward the antenna 40 in a direction from away the outer circumferential surface of the fixed shaft 41. Due to the bearing 43 provided between the intermediate sleeve 4201 and the fixed shaft 41, the inner diameter of the intermediate sleeve 4201 is sufficiently larger than an outer diameter of the fixed shaft 41. Therefore, an inner surface of the intermediate sleeve 4201 does not make sliding contact with the antenna 40 and the wire 401 when the fixed shaft 41 is inserted into the intermediate sleeve 4201 or during the rotation of the intermediate sleeve 4201 relative to the fixed shaft 41.

As shown in FIG. 2, the fixed shaft 41 has a groove-like recess portion 412 provided in the outer circumferential surface along its longitudinal direction. The width of the recess portion 412 along the circumferential direction of the fixed shaft 41 is slightly larger than the width of the wire 401. The depth of the recess portion 412 is slightly larger than the thickness of the wire 401. The antenna 40 is attached over the magnetic sheet 45 after the magnetic sheet 45 is attached to the outer circumferential surface of the fixed shaft 41 by adhesion.

A protection sleeve 50 is provided near an end portion of the fixed shaft 41, which is closer to the side wall 201. The protection substantially the same inner diameter as the outer diameter of the fixed shaft 41 and has an outer diameter slightly smaller than an inner diameter of the bearing 43. That is, a gap corresponding to the thickness of the protection sleeve 50 is formed between the intermediate sleeve 4201 and the fixed shaft 41. The protection sleeve 50 is interposed between the wire 401 and the bearing 43 and is fitted and fixed to the end portion of the fixed shaft 41.

When the intermediate sleeve 4201 is mounted on the fixed shaft 41 by inserting the fixed shaft 41 fixed to the protection sleeve 50 into the intermediate sleeve 4201 with the bearing 43 fitted to the one end, an inner peripheral surface of the bearing 43 is held in contact with an outer circumferential surface of the protection sleeve 50. Since the inner diameter of the bearing 43 is slightly larger than the outer diameter of the protection sleeve 50 and there is a small gap between both, the intermediate sleeve 4201 with the bearing 43 is rotatable relative to the fixed shaft 41 with the protection sleeve 50. The protection sleeve 50 prevents a malfunction where the intermediate sleeve 4201 makes sliding contact with the wire 401 arranged and received in the recess portion 412 of the fixed shaft 41 when the intermediate sleeve 4201 is rotated relative to the fixed shaft 41.

FIG. 4 is a perspective view showing the paper tube 30 of the ribbon roll, which is mounted on the feed shaft 10. As shown in FIG. 4, the paper tube 30 of the ribbon roll includes an IC tag 32 that performs wireless communication. The IC tag 32 has, for example, a rectangular sheet-shape. The IC tag 32 is attached to an outer circumferential surface 301 of the paper tube 30 at a substantially axial center of the paper tube 30 by adhesion. The ink ribbon is wound around the outer circumferential surface of the paper tube 30, superimposed on the outside of the IC tag 32. It is sufficient that the IC tag 32 is installed in the paper tube 30. The IC tag 32 may be installed in, for example, the inner surface of the paper tube 30 or a middle portion between the outer circumferential surface and the inner surface of the paper tube 30. The IC tag is an example of a wireless tag described in the scope of claims of this application.

FIG. 5 is a block diagram showing an exemplary control system of the label printer 100. As shown in FIG. 5, the label printer 100 includes a controller 60 that sets printing speed in accordance with the type of ink ribbon. The controller 60 is constituted by, for example, a central processing unit (CPU). The processor may be, for example, a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor may be a combination of some of them.

The controller 60 connects a power switch 206, an operation device 202, a display device 204, a memory 62, a reader/writer 63, a label paper conveyance motor 64, an ink ribbon feed motor 65, an ink ribbon take-up motor 66, and a communication device 67.

The memory 62 stores a control program and also stores data regarding printing speed appropriate depending on the type of ink ribbon. The reader/writer 63 wirelessly communicates the IC tag 32 via the antenna 40 to write data in the IC tag 32 and read data from the IC tag 32. The reader/writer 63 is an example of a data communication unit. The label paper conveyance motor 64 rotates the label paper conveyance roller 68 to pull out the label paper from the label paper roll. The ink ribbon feed motor 65 rotates the intermediate sleeve 4201 of the feed shaft 10. The ink ribbon take-up motor 66 rotates the intermediate sleeve 4202 (FIG. 1) of the take-up shaft 12. The communication device 67 sends/receives various data to/from an external device ED, such as a host computer.

When the power switch 206 is turned on, the controller 60 controls the reader/writer 63 to scan data from the IC tag 32 via the antenna 40. In particular, in a case of replacing the ribbon roll of the feed shaft 10, the label printer 100 is configured so that the cover 4 of the casing 2 can be opened and the ribbon roll can be replaced only after the power switch 206 is turned off. In other words, in a case of replacing the ribbon roll of the feed shaft 10, the user of the label printer 100 needs to replace the ribbon roll once the power switch 206 is turned off. Therefore, in a case of using the label printer 100 after the ribbon roll of the feed shaft 10 is replaced, the power switch 206 is turned on, and then data is scanned from the IC tag 32. Alternatively, the controller 60 may store the number of times the cover 4 is opened and closed in the memory 62 in a non-volatile manner and include an open/close counter that mechanically counts the number of times the cover 4 is opened and closed as a count value that can be scanned by the controller 60, such that the controller 60 can scan data from the IC tag 32 in a case where the count value of the open/close counter is different from the number of times of opening and closing stored in the memory 62 when the power switch 206 is turned on.

The IC tag 32 stores data regarding the ink ribbon wound around the paper tube 30. The data regarding the ink ribbon includes, for example, the product name, type (for plain paper or thick paper), width, length, date of manufacture, (manufacture's) serial number, and the remaining amount of ink ribbon.

After that, the controller 60 reads out from the memory 62 the printing speed appropriate depending on the type of ink ribbon scanned from the IC tag and controls a conveyance motor group including the label paper conveyance motor 64, the ink ribbon feed motor 65, and the ink ribbon take-up motor 66 to achieve this printing speed. The controller 60 controls the conveyance motor group including the label paper conveyance motor 64, the ink ribbon feed motor 65, and the ink ribbon take-up motor 66 to perform printing at this printing speed until the ink ribbon is used up.

Moreover, the controller 60 rewrites the remaining amount of ink ribbon stored in the memory 62 when each printing task is completed. The controller 60 is capable of displaying the remaining amount of ink ribbon via the display device 204.

Next, results of success or failure of data scanning for each angle of the IC tag mounted on the paper tube, which is performed by a conventional antenna, will be described. A reader/writer with the conventional antenna cannot scan the data of the IC tag depending on the angle between the antenna and the IC tag in some cases. Hereinafter, the conventional antenna will be referred to as an antenna 402. The antenna element that the antenna 402 has will be referred to as an antenna element 4021.

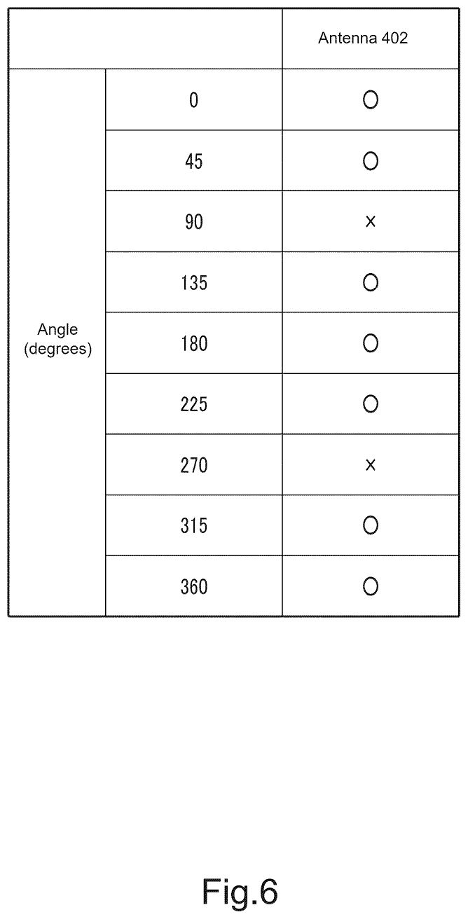

FIG. 6 is a diagram showing exemplary results of success or failure of data scanning for each angle of the IC tag 32 installed in the paper tube 30, which is performed by the antenna 402 mounted on the fixed shaft 41. In FIG. 6, the circle marks represent successes of data scanning and the “x”-marks represent failures of data scanning.

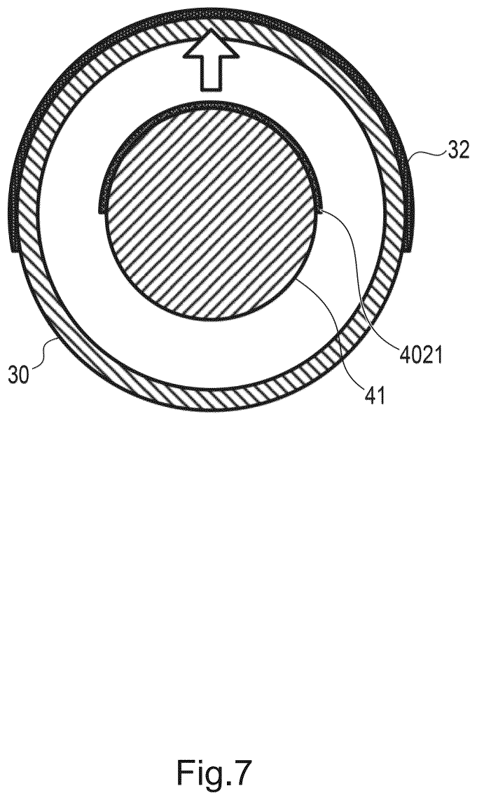

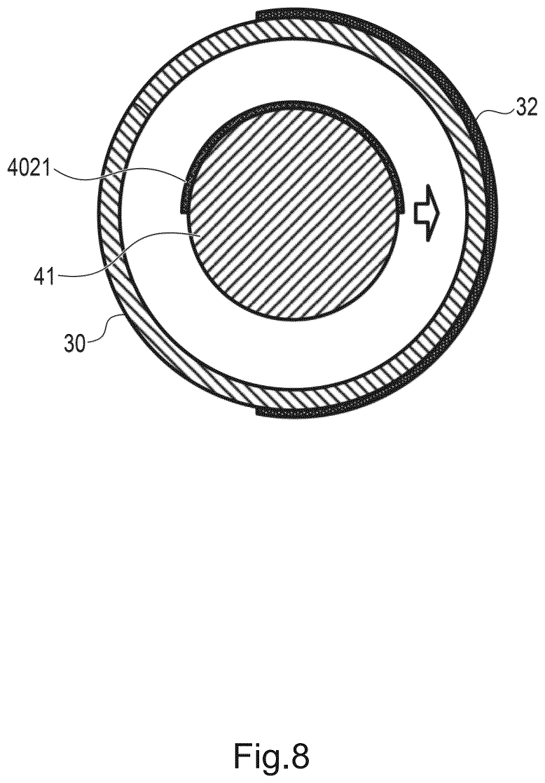

For easy understanding of the comparison of the conventional antenna 402 with an antenna 403 according to an example to be described later, the conventional antenna 402 is described using the above-mentioned label printer 100 here. That is, the conventional antenna 402 is described, assuming that the conventional antenna 402 is provided in the label printer 100. FIG. 7 is a schematic view showing a state in which the angle of the IC tag 32 relative to the antenna 402 is 0 degrees. FIG. 8 is a schematic view showing a state in which the angle of the IC tag 32 relative to the antenna 402 is 90 degrees. In FIGS. 7 and 8, the white arrows show the main direction and magnitude of the magnetic field received by the IC tag 32.

For example, it is assumed that the width of the antenna element 4021 of the antenna 402 in the circumferential direction of the fixed shaft 41 is, as shown in FIGS. 7 and 8, a half of the fixed shaft 41 in the circumferential direction, i.e., the antenna element 4021 of the antenna 402 covers a half of the fixed shaft 41 in the circumferential direction. In this case, as shown in FIGS. 7 and 8, the magnetic field generated by the antenna 402 is strong at the center portion of the antenna 402 and weak at the end portion of the antenna 402.

In the IC tag 32 whose maximum width is equal to or larger than the half of the paper tube 30 in the circumferential direction, in a case where the IC tag 32 is at 0 degrees relative to the antenna element 4021 of the antenna 402 as shown in FIG. 7, i.e., in a case where a center point of the width of the IC tag 32 in the circumferential direction coincides with a center point of the width of the antenna element 4021 of the antenna 402 in the circumferential direction, the data scanning is successful because of the strong magnetic field generated by the antenna element 4021 of the antenna 402. On the other hand, in a case where the IC tag 32 is located at a position that is a direction of 90 degrees relative to the antenna element 4021 of the antenna 402 as shown in FIG. 8, i.e., in a case where the antenna element 4021 of the antenna 402 and the IC tag 32 are in a orthogonal relationship, the data scanning fails because the magnetic field generated by the antenna element 4021 of the antenna 402 is weak and is not easily received by IC tag 32. The same is true for the positional relationship of 270 degrees, which is the position of −90 degrees. It should be noted that the magnetic field in the direction of 180 degrees (behind the antenna element 4021 of the antenna 402) is assumed to be stronger than that in the direction of ±90 degrees because the data reading is successful.

Since the basic operation is electromagnetic induction, if the magnetic field generated by the antenna element 4021 of the antenna 402 does not penetrate the loop antenna of the IC tag 32, no electromotive force is generated in the IC tag 32 and communication is impossible. This situation where the communication is impossible corresponds to a case where the positional relationship in which the IC tag 32 is at ±90 degrees relative to the antenna 402.

As describe above, the conventional antenna cannot scan data depending on the angle with the IC tag, and cannot be said to be capable of favorable data communication.

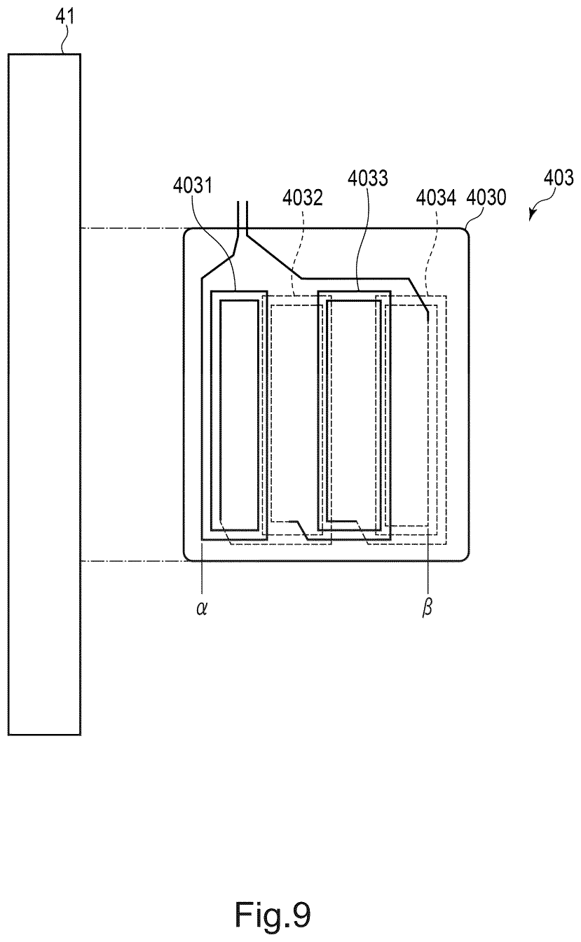

FIG. 9 is a diagram showing the example of the antenna 40. Hereinafter, the antenna 40 according to the example will be referred to as the antenna 403. In FIG. 9, the fixed shaft 41 is shown alongside the antenna 403 for reference. Moreover, the recess 412 of the fixed shaft 41, the wire 401, the magnetic sheet 45, and the like are omitted. It should be noted that, for the sake of description, the thickness of the antenna 40 and the thickness of the magnetic sheet 45 attached to the fixed shaft 41 are not considered.

The antenna 403 is obtained by winding a continuous metal foil in a constant direction multiple times and continuously arranging four antenna elements 4031, 4032, 4033, and 4034 each forming a rectangular loop in a single direction along a short direction of the loop. The antenna 403 forms an antenna element 4031 and an antenna element 4033 on a front surface of a flexible substrate 4030. The antenna 403 forms an antenna element 4032 and an antenna element 4034 on a back surface of the flexible substrate 4030. For the sake of description, in FIG. 9, the antenna element 4031 and the antenna element 4033 formed on the front surface of the flexible substrate 4030 is shown as a single solid line. In FIG. 9, the antenna element 4032 and the antenna element 4034 formed on the back surface of the flexible substrate 4030 is shown as a single dotted line. Moreover, in FIG. 9, the antenna elements and the other wires of the antenna 403 are each shown as a single solid line or a single dotted line, though the metal foil of the antenna elements and the other wires of the antenna 403 is actually provided, for example, with a width of approximately 0.5 mm to 1 mm in order to allow current to flow efficiently.

The antenna elements 4031, 4032, 4033, and 4034 of the antenna 403 are wound in the same orientation as viewed from the front or back surface of the flexible substrate 4030. For example, as shown in FIG. 9, each loop of the antenna elements 4031, 4032, 4033, and 4034 is wound in a counterclockwise direction as viewed from the front surface.

In FIG. 9, it is assumed that the side on which the antenna element 4031 of the antenna 403 is formed is one end and the side on which the antenna element 4034 is formed is the other end. In the antenna 403, the other end side of the antenna element 4031 and the one end side of the antenna element 4032 overlap each other. Similarly, in the antenna 403, the other end side of the antenna element 4032 and the one end side of the antenna element 4033 overlap each other and the other end side of the antenna element 4033 and the one end side of the antenna element 4034 overlap each other. That is, the antenna 403 has an antenna element group in which the four antenna elements 4031, 4032, 4033, and 4034 are arranged in a single direction, overlapping as the adjacent antenna elements 4031, 4032, 4033, and 4034. On the other hand, in FIG. 9, the point α shows the outermost point of the one end side of the antenna element 4031 and the point β shows the innermost point of the other end side of the antenna element 4034. A width from the point α to the point β of the antenna 403 is set to be substantially equal to the outer circumference of the fixed shaft 41. With this configuration, the antenna 403 is installed in the outer circumferential surface of the fixed shaft 41 so that the one end side of the antenna element 4031 and the other end side of the antenna element 4034 overlap each other because the longitudinal directions of the antenna elements 4031, 4032, 4033, and 4034 are along the longitudinal direction of the fixed shaft 41.

As described above, the antenna 403 is installed in the outer circumferential surface of the fixed shaft 41 so that the longitudinal directions of the antenna elements 4031, 4032, 4033, and 4034 are along the longitudinal direction of the fixed shaft 41. That is, the antenna 403 is arranged so that the antenna elements 4031, 4032, 4033, and 4034 are along the circumferential direction of the fixed shaft 41. That is, the IC tag 32 installed in the paper tube 30 faces the antenna elements 4031, 4032, 4033, and 4034 of the antenna 403 in order when the paper tube 30 mounted on the feed shaft 10 is rotated.

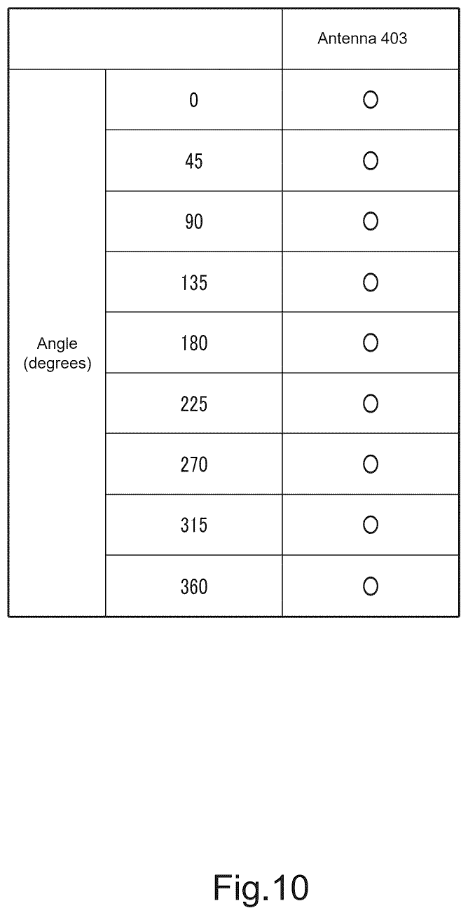

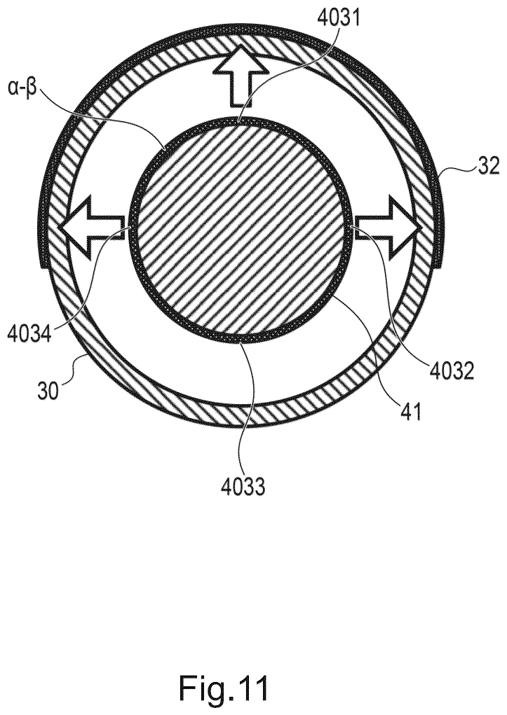

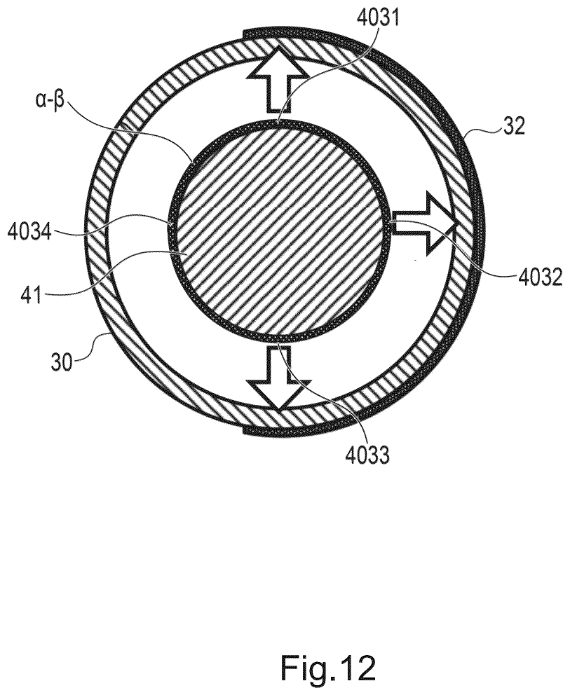

FIG. 10 is a diagram showing exemplary results of success or failure of data scanning for each angle of the IC tag 32 installed in the paper tube 30, which is performed by the antenna 403 mounted on the fixed shaft 41. In FIG. 10, the circle marks represent successes of data scanning. FIG. 11 is a schematic view showing a state in which the angle of the IC tag 32 relative to the antenna 403 is 0 degrees. FIG. 12 is a schematic view showing a state in which the angle of the IC tag 32 relative to the antenna 403 is 90 degrees. In FIGS. 11 and 12, the white arrows show the main direction and magnitude of the magnetic field received by the IC tag 32.

For example, the width of the α point to the β point of the antenna 403 in the circumferential direction of the fixed shaft 41 turns along the circumferential direction of the fixed shaft 41 along as shown in FIGS. 11 and 12, i.e., the antenna elements 4031, 4032, 4033, and 4034 of the antenna 403 are arranged to cover the area in the circumferential direction of the fixed shaft 41. In this case, the magnetic field generated by the antenna 403 has uniform strength in all directions as shown in FIGS. 11 and 12.

In the IC tag 32 whose maximum width is equal to or larger than the half of the paper tube 30 in the circumferential direction, in a case where the IC tag 32 is at 0 degrees relative to the antenna element 4031 of the antenna 403 as shown in FIG. 11, i.e., in a case where the center point of the width of the IC tag 32 in the circumferential direction coincides with the center point of the width of the antenna element 4031 in the circumferential direction, the data scanning is successful because of a strong magnetic field generated by the antenna element 4031. Moreover, in a case where the IC tag 32 is located at a position which is the direction of 90 degrees relative to the antenna element 4031 of the antenna 403 as shown in FIG. 12, i.e., in a case where the antenna element 4031 and the IC tag 32 are in a orthogonal relationship, the IC tag 32 is at 0 degrees relative to the antenna element 4032, and the data scanning is successful because of a strong magnetic field generated by the antenna element 4032. In the positional relationship in which the IC tag 32 is at 270 degrees relative to the antenna element 4031 of the antenna 403, which is the position of −90 degrees, the IC tag 32 is at 0 degrees relative to the antenna element 4034, and the data scanning is also successful. In the direction of 180 degrees (behind the antenna element 4031) relative to the antenna element 4031, the IC tag 32 is at 0 degrees relative to the antenna element 4033, and the data scanning is also successful.

As described above, the label printer 100 according to the present embodiment is capable of communication at any angle of the IC tag 32 attached to the paper tube 30 relative to the antenna 403 because the antenna 403 is installed in the feed shaft 10 on which the ribbon roll with the ink ribbon wound around the paper tube 30 is mounted.

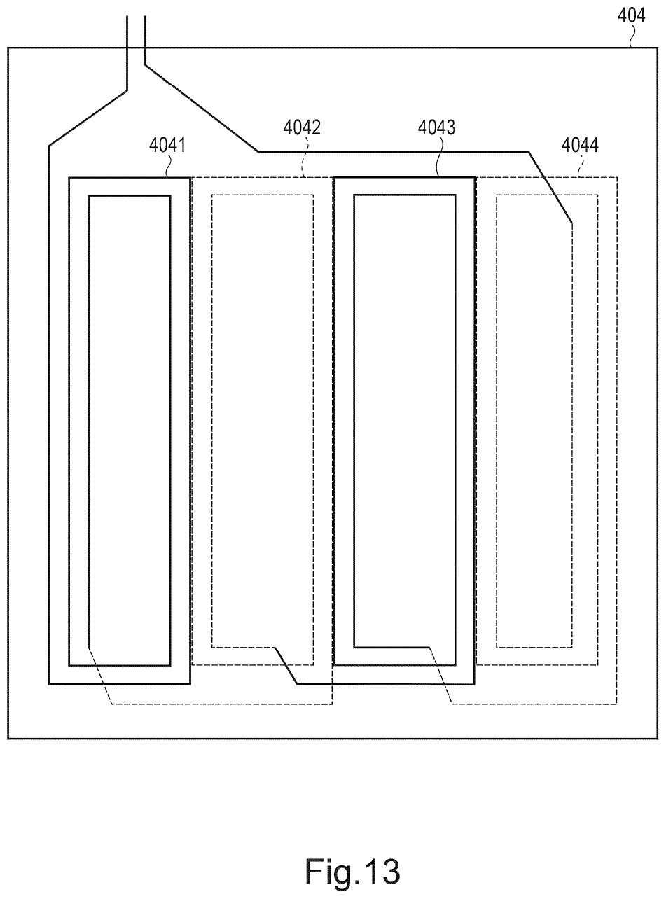

FIG. 13 is a view showing a modified example of the antenna 403. Hereinafter, the antenna in FIG. 13 will be referred to as an antenna 404. As shown in FIG. 13, antenna elements 4041, 4042, 4043, and 4044 of the antenna 404 do not overlap the adjacent antenna elements, but they are formed with no gaps. That is, the gap between the adjacent antenna elements is 0 mm. Then, in FIG. 13, it is assumed that a width from the outermost point of the left half side of the antenna element 4041 to the outermost point of the right half side of the antenna element 4044 is substantially the same as the outer circumference of the fixed shaft 41. Due to such an antenna 404 mounted on the fixed shaft 41, the gap between adjacent portions of the antenna element 4041 on the one end side and the antenna element 4044 on the other end side is 0 mm. It should be noted that for the sake of description, in FIG. 13, the antenna element 4041 and the antenna element 4043, which are formed in the front surface of the antenna 404, are each shown as a single solid line. In FIG. 13, the antenna element 4042 and the antenna element 4044, which are formed on the back surface of the antenna 404, are each shown as a single dotted line. Moreover, in FIG. 13, the antenna elements and the other wires of the antenna 404 are each shown as a single solid line or a single dotted line, though the metal foil of the antenna elements and the other wire of the antenna 404 is actually provided, for example, with a width of approximately 0.5 mm to 1 mm in order to allow current to flow efficiently.

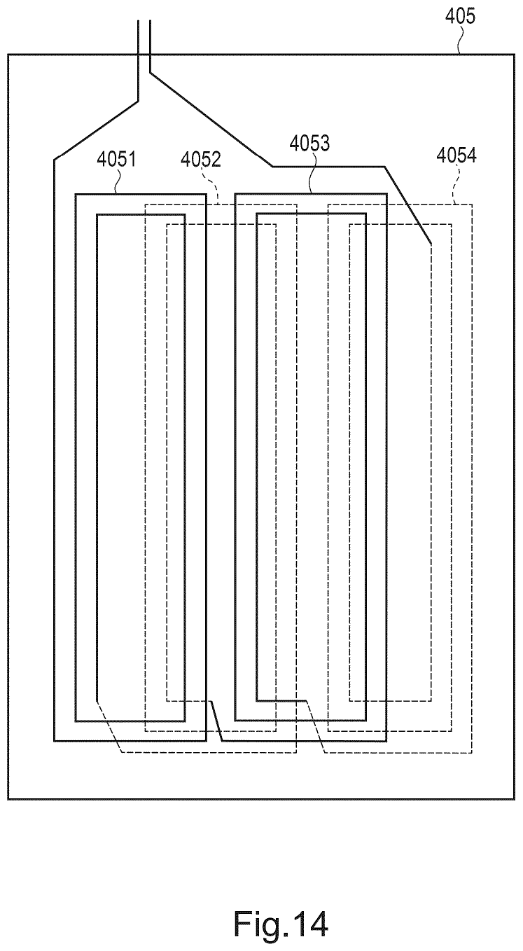

FIG. 14 is a view showing still another modified example of the antenna 403. Hereinafter, the antenna in FIG. 14 will be referred to as an antenna 405. As shown in FIG. 14, the antenna elements 4051, 4052, 4053, and 4054 of the antenna 405 are formed so that the loops cross over each other toward the centers of the adjacent antenna elements. Here, for the sake of convenience, it is assumed that the gap between the adjacent antenna elements is-2 mm. Also in this modified example, in a case where the antenna 405 is mounted on the fixed shaft 41, the antenna element 4051 on the one end side and the antenna element 4054 on the other end side are installed so that they cross over each other in their loops, and the gap between the loops is-2 mm. It should be noted that for the sake of description, in FIG. 14, the antenna element 4051 and the antenna element 4053, which are formed on the front surface of the antenna 405, are each shown as a single solid line. In FIG. 14, the antenna element 4052 and the antenna element 4054, which are formed on the back surface of the antenna 405, are each shown as a single dotted line. Moreover, in FIG. 14, the antenna elements and the other wires of the antenna 405 are each shown as a single solid line or a single dotted line, though the metal foil of the antenna elements and the other wire of the antenna 405 is actually provided, for example, with a width of approximately 0.5 mm to 1 mm in order to allow current to flow efficiently.

Note that if there is a large gap between the adjacent antenna elements of the antenna, it can create a point where the data scanning is impossible. For example, according to test results, the gap between the loops of −1 mm to 1 mm is suitable for data scanning because it can stably perform data scanning.

In the above-mentioned embodiment, the number of antenna elements of the antennas 403, 404, and 405 is set to four. The number of antenna elements is not limited to four. The number of antenna elements increases or decreases depending on the diameter of the shaft to which the antenna is provided. The outer diameter of the fixed shaft 41 according to the above-mentioned embodiment is, for example, 12 mm.

In the above-mentioned embodiment, the antenna elements of the antennas 403, 404, and 405 are formed by patterning the metal foil on the front surface of the flexible substrate. In another embodiment, the antenna elements of the antennas 403, 404, and 405 may be formed by winding a coil instead of the metal foil.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing apparatus, comprising:
a shaft that is arranged to be inserted into a tubular material including a wireless tag and rotatably supports the tubular material; and
an antenna that has an antenna element group including a plurality of antenna elements and performs data communication with the wireless tag, the antenna element group being arranged to cover an area in a circumferential direction of the shaft.

2. The printing apparatus according to claim 1, wherein
the plurality of antenna elements of the antenna element group is arranged in a single direction with no gaps between the adjacent antenna elements.

3. The printing apparatus according to claim 2, wherein
the antenna is arranged so that the plurality of antenna elements of the antenna element group covers the area in the circumferential direction of the shaft.

4. The printing apparatus according to claim 1, wherein
the antenna element group is arranged in a single direction with the plurality of antenna elements overlapping the adjacent antenna elements.

5. The printing apparatus according to claim 4, wherein
the antenna is arranged so that the plurality of antenna elements of the antenna element group covers the area in the circumferential direction of the shaft.

6. The printing apparatus according to claim 3, wherein
one end side and another end side of the plurality of antenna elements arranged to cover the area in the circumferential direction of the shaft are arranged with no gaps.

7. The printing apparatus according to claim 1, wherein
the antenna element group includes a plurality of loop-shaped antenna elements wound in the same orientation, and
the plurality of loop-shaped antenna elements is arranged in a single direction.

8. The printing apparatus according to claim 1, wherein
the shaft on which a ribbon roll with a long ink ribbon wound around the tubular material is removably mounted and rotatably supports the mounted roll, the ink ribbon retaining ink.

9. The printing apparatus according to claim 8, further comprising:
a conveyance motor group including a plurality of motors for rotating the shaft and conveying the ink ribbon over the print sheet so as to feed the ink ribbon from the ribbon roll; and
a printing device that heats the ink ribbon conveyed over the print sheet and transfers the ink in the ink ribbon to the print sheet.

10. The printing apparatus according to claim 9, further comprising
a controller that controls printing speed by controlling the motors on a basis of data, the data being read from the wireless tag via the antenna.
